(19) United States
(12) Patent Application Publication
(10) Pub. No.: US 2013/0183566 A1
(43) Pub. Date: Jul. 18, 2013

(54) Thermal Management Structures for Battery Packs

(71) Applicants: Ryan J. Wayne, Brecksville, OH (US); Jonathan Taylor, Cleveland, OH (US); Martin D. Smalc, Parma, OH (US); Elliott Fishman, Sharker Heights, OH (US)

(72) Inventors: Ryan J. Wayne, Brecksville, OH (US); Jonathan Taylor, Cleveland, OH (US); Martin D. Smalc, Parma, OH (US); Elliott Fishman, Sharker Heights, OH (US)

(73) Assignee: GrafTech International Holdings Inc., Parma, OH (US)

(21) Appl. No.: 13/876,302

(22) PCT Filed: Sep. 30, 2011
(86) PCT No.: PCT/US11/54228

§ 371 Date: Mar. 27, 2013

Related U.S. Application Data
(60) Provisional application No. 61/388,844, filed on Oct. 1, 2010.

(51) Int. Cl. H01M 10/50

(52) U.S. Cl. CPC H01M 10/504
USPC 429/120

(57) ABSTRACT

A battery pack includes a plurality of cylindrical battery cells. Damage caused by thermal energy generated in the battery pack is minimized by a one or more graphite sheets in contact with a portion of each cylindrical battery cell.

### PRIORITY CLAIM

This Application claims priority to U.S. Provisional Application Ser. No. 61/388,844 filed on Oct. 1, 2010 and titled Thermal Management Structures for Battery Packs.

### TECHNICAL FIELD

The present disclosure relates to thermal management for cylindrical cell battery packs.

### BACKGROUND

Modern devices are increasingly depending on rechargeable batteries to provide operational power. Whether the device is a vehicle or a computer, battery performance is a critical element of overall device performance.

One of the most common form factors for batteries is a cylindrical shape, and one of the most common types of battery is a lithium ion battery. The three primary functional components of a lithium-ion battery are the anode, cathode and the electrolyte. The anode of a conventional lithium-ion cell is made from a carbon material (most commonly graphite). The cathode is a metal oxide which is generally one of three materials: a layered oxide (i.e. lithium cobalt oxide), a polyanion (i.e. lithium iron phosphate) or a spinel (i.e. lithium manganese oxide). The electrolyte is a lithium salt in an organic solvent and is typically a mixture of organic carbonates such as ethylene carbonate or diethyl carbonate containing complexes of lithium ions. These non-aqueous electrolytes generally use non-coordinating anion salts such as lithium hexafluorophosphate (LiPF6), lithium hexafluoroarsenate monohydrate (LiAsF6), lithium perchlorate (LiC1O4), lithium tetrafluoroborate (LiBF4), and lithium triflate (LiCF3SO3).

It is common in many applications to include a plurality of individual battery cells in an electronic circuit to provide power to higher loads for longer periods of time. When grouping together multiple battery cells, thermal management issues are presented. Specifically, a typical lithium ion battery has a preferred operating temperature range of ˜20 C to ˜45 C, (and up to 60 C for some cell chemistries). However the heat generated during high rate charging and discharging can cause the temperature of the cells to quickly rise out of this range, leading to premature cell degradation and failure. This problem is compounded when multiple cells are assembled tightly in large battery packs with relatively small surface area to volume ratios.

To ensure high performance and long life, cells in large battery packs are often cooled by flowing air over the outer surface of the cell pack. Additionally, it may be necessary to heat a battery pack by flowing warmed air over the outer surface of the battery pack to improve ‘cold start’ performance. However, the temperature regulation performance of these configurations is limited by the area over which the air can flow. Thus, there is a need in the art for improved thermal management schemes in multi-cell battery packs.

### SUMMARY OF THE INVENTION

According to one aspect of the present invention, a battery pack includes a plurality of cylindrical battery cells having a longitudinal length and a radial outer surface and a plurality of heat spreaders including a graphite sheet, each cylindrical battery being positioned in a heat spreader and the heat spreader extending at least substantially the entire longitudinal length of the battery cell and contacting at least a portion of the radial outer surface.

According to another aspect of the present invention, a battery pack includes a plurality of cylindrical battery cells having a longitudinal length and a radial outer surface. The cylindrical battery cells are arranged in at least one linear row and at least one heat spreader includes a graphite sheet which extends at least substantially the entire longitudinal length of the cylindrical battery cells and the entire length of the linear row. A single heat spreader contacts at least a portion of the radial outer surface of each cylindrical battery in the row.

### BRIEF DESCRIPTION OF THE DRAWINGS

FIG. 1 is an isometric view of a first embodiment of a battery pack with several battery cells removed to show interior details.

FIG. 2 is a top view of the battery pack shown in FIG. 1.

FIG. 3 is an isometric view of a second embodiment of a battery pack with several battery cells removed to show interior details.

FIG. 4 is a top view of the battery pack shown in FIG. 3.

FIG. 5 is an isometric view a single battery cell and heat spreader used in a third embodiment of a battery pack.

FIG. 6 is a top view of a battery pack made of a plurality of battery cells shown in FIG. 5.

FIG. 7 is an isometric view of a fourth embodiment of a battery pack.

FIG. 8 is top view of the battery pack shown in FIG. 7.

FIG. 9 is an isometric view of a fifth embodiment of a battery pack.

FIG. 10 is a top view of the battery pack shown in FIG. 9.

FIG. 11 is an isometric view of a sixth embodiment of a battery pack.

FIG. 12 is a top view of the battery pack shown in FIG. 11.

FIG. 13 is an isometric view of a seventh embodiment of a battery pack.

FIG. 14 is a top view of the battery pack shown in FIG. 13.

FIG. 15 is an isometric view of an eighth embodiment of a battery pack.

FIG. 16 is a top view of the battery pack shown in FIG. 15.

FIG. 17 is an isometric view of a ninth embodiment of a battery pack.

FIG. 18 is a top view of the battery pack shown in FIG. 17.

FIG. 19 is a top view of a tenth embodiment of a battery pack.

FIG. 20 is an isometric view of the battery pack shown in FIG. 19.

FIG. 21 is an isometric view of an eleventh embodiment of a battery pack.

FIG. 22 is a top view of the battery pack shown in FIG. 21.

FIG. 23 is side view of a twelfth embodiment of a battery pack.

FIG. 24 is a top view of the battery pack shown in FIG. 23.

FIG. 25a is an isometric view of a thirteenth embodiment of a battery pack.

FIG. 25b is an isometric view of a single heat spreader used the battery pack shown in FIG. 25a.

FIG. 26 is a top view of the battery pack shown in FIG. 25a.

FIG. 27 is a top view of a of the battery pack shown in FIG. 25a with a heat sink such as a cold plate or heat exchange manifold.

FIG. 28 is an isometric view of the battery pack shown in FIG. 27.

FIG. 29 is a top view of a fourteenth embodiment of a battery pack with several battery cells removed to show interior details.

FIG. 30 is an isometric view of the battery pack shown in FIG. 29

### DETAILED DESCRIPTION OF THE INVENTION

As will become evident, the various embodiments disclosed herein effectively spread heat throughout the assembly to thereby promote thermal homogeneity. In one or more embodiments, thermal performance is further improved by increasing the surface area over which air can flow within and around a battery pack. This in turn improves the dissipating capabilities of the battery pack with minimal impact on the volumetric energy density of the pack.

In one or more embodiments below, the battery pack includes one or more heat spreaders made of a graphite sheet, extruded graphite, and/or thermally conductive graphite foam materials. The graphite sheet may be compressed expanded natural graphite, resin impregnated compressed expanded natural graphite, graphitized polyimide sheet or combinations thereof. The graphite sheet may optionally be coated with a thin film of dielectric material on one or both sides to provide electrical insulation. In one or more embodiments, the graphite sheet exhibits an in-plane thermal conductivity of at least 150 W/m*K. In still other embodiments, the graphite sheet exhibits an in-plane thermal conductivity of at least 300 W/m*K. In still other embodiments the graphite sheet exhibits an in-plane thermal conductivity of at least 700 W/m*K. In still other embodiments, the graphite sheet exhibits an in-plane thermal conductivity of at least 1500 W/m*K. In one embodiment, the graphite sheet material may be from 10 to 1500 microns thick. In other embodiments the graphite material may be from 20 to 40 microns thick. Suitable graphite sheets and sheet making processes are disclosed in, for example, U.S. Pat. Nos. 5,091,025 and 3,404,061, the contents of which are incorporated herein by reference.

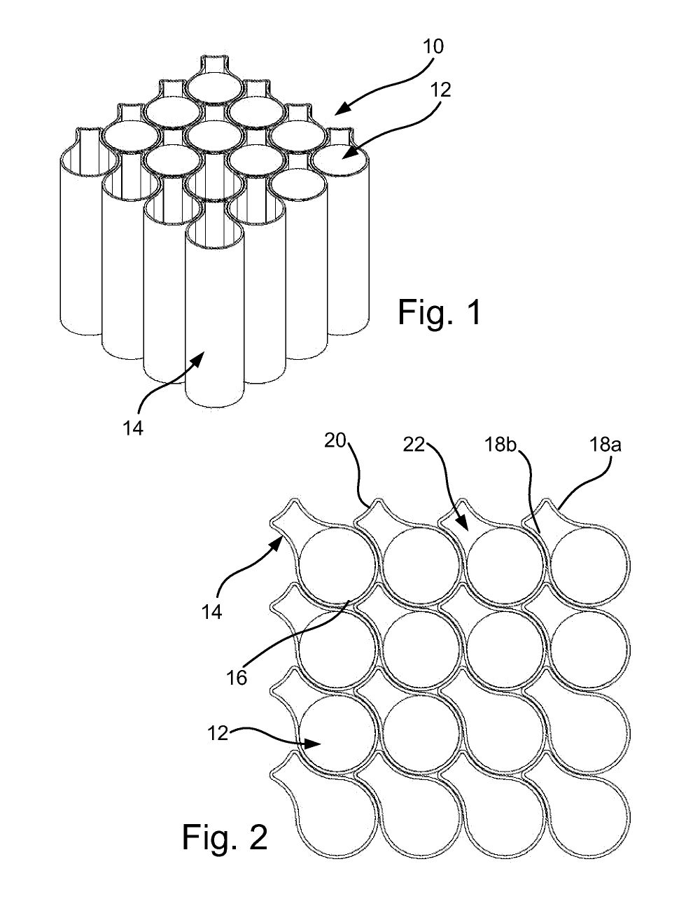

With reference now to FIGS. 1 and 2, a first embodiment of a battery pack is shown and generally indicated by the numeral 10. Battery pack 10 includes a plurality of cylindrical battery cells 12 arranged in aligned rows. A heat spreader 14 made of graphite sheet material is wrapped around each battery cell in a manner which, as will be described below in greater detail, improves thermal performance. In one embodiment, the heat spreader 14 is generally tubular and extends longitudinally substantially the entire longitudinal length of the battery cell 12. In other embodiments, the heat spreader 14 is longer than the battery cell 12 so that a portion extends beyond battery cell 12 at one or both ends.

In cross-section, heat spreader 14 is generally piscine shaped, having a substantially semi-circular portion 16 with a diameter sized so that the interior surface of portion 16 is substantially flush with, and in thermal contact with, the radial outer surface of battery cell 12. A pair of curved legs 18a and 18b extend from semicircular portion 16 away from the radial outer surface of battery cell 12. Each curved leg 18 includes a radius sized so that each leg is substantially flush with, and in thermal contact with, the semi-circular portion 16 of an adjacent heat spreader 14. Thus, with particular reference to FIG. 2, the curved leg 18a is in thermal contact with semi-circular portion 16 of heat spreader 14 in the row directly above. Likewise, the curved leg 18b is in thermal contact with the semi-circular portion 16 of heat spreader 14 directly adjacent to the left in the same row.

Heat spreader 14 further includes a connecting leg 20 having a radius sized so that it is substantially flush with, and in thermal contact with, the semi-circular portion 16 of an adjacent heat spreader 14. With particular reference to FIG. 2, the connecting leg 20 is in thermal contact with the semi-circular portion 16 of heat spreader 14 above and to the left. In this manner, it can be seen, that the heat sink 14 of a given cell 12 is in thermal contact with the heat sink of three adjacent cells. Further, an interior channel 22 is formed by a portion of the radial outer surface of cell 12, legs 18 and 20. In one embodiment, a fluid or gas such as air, may be directed through one or more of the plurality of interior channels 22 to aid in heat removal or regulation.

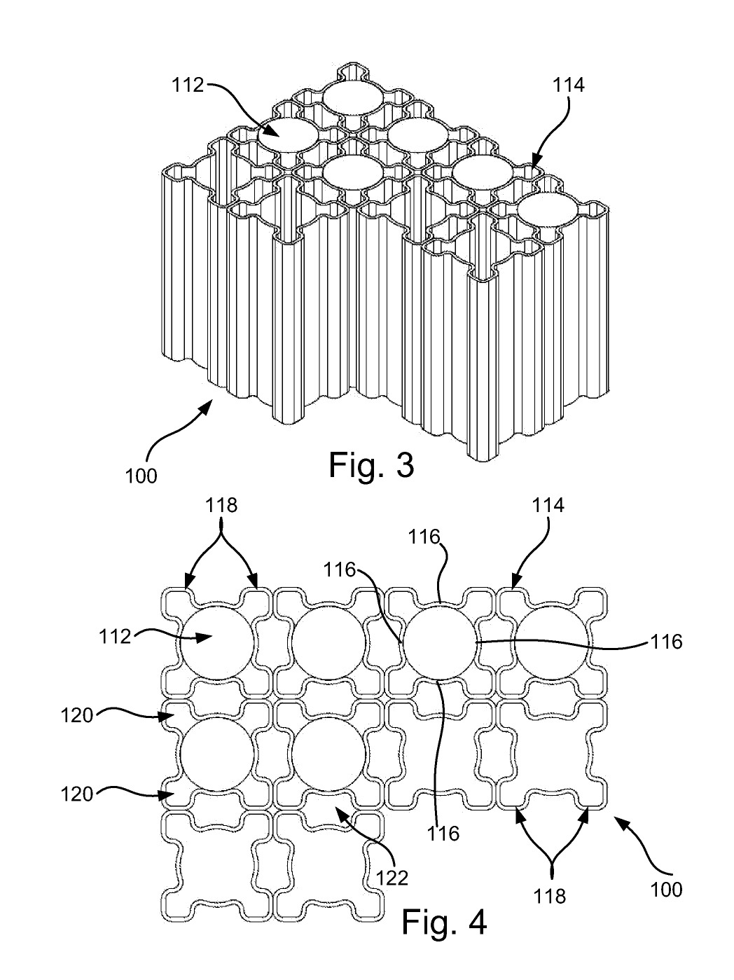

With referenced now to FIGS. 3 and 4, a second embodiment of a battery pack is shown and generally indicated by the numeral 100. Battery pack 100 includes a plurality of cylindrical battery cells 112 arranged in aligned rows. Each row may have any number of cells 112, and likewise, any number of rows may be employed. A heat spreader 114 made of graphite sheet material or extruded graphite is positioned around each battery cell 112 in a manner which, as will be described below in greater detail, improves thermal performance. In one embodiment, the heat spreader 114 is generally tubular and extends substantially the entire longitudinal length of the battery cell 112. In other embodiments, the heat spreader 114 is longer than the battery cell 112 so that it extends beyond battery cell 112 at one or both ends.

In cross-section, each heat spreader 114 includes is generally cruciform shaped, having four equidistant arced sections 116. Arced sections 116 include a radius sized so that the interior surface thereof is substantially flush, and in thermal contact with the radial outer surface of battery cell 112. A projection 118 is interposed between each arced section 16 and extends away from the respective battery cell 112. Each projection 118 is looped, having four legs, each arranged at generally 90 degrees from the adjacent leg. Heat spreader 114 is sized so that each projection 118 engages the projection 118 of one or more adjoining heat spreaders 114. In conjunction with the radial exterior surface of the battery cell 112, each projection 118 forms a longitudinally extending interior channel 120. An inter-cell channel 122 is formed between each adjacent heat spreader 114 by two arced sections 116 and portions of four projections 118. In one embodiment, a fluid or gas such as air may be directed through one or more of the plurality of interior channels 120 and/or inter-cell channels 122 to aid in heat removal or regulation.

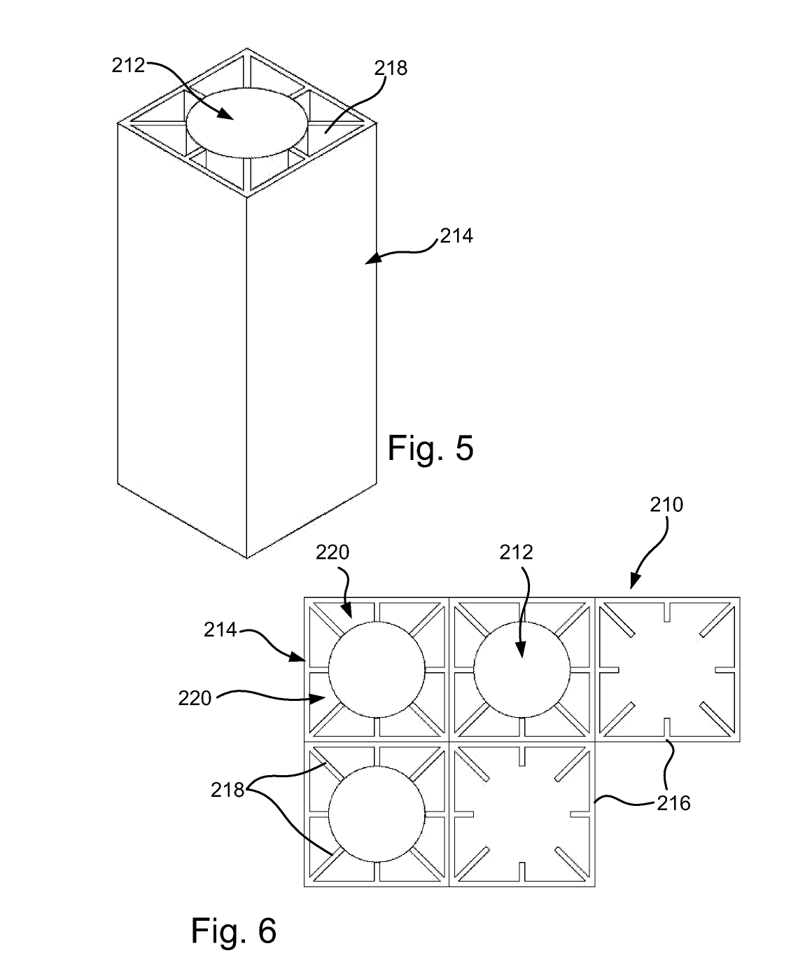

With referenced now to FIGS. 5 and 6, a third embodiment of a battery pack is shown and generally indicated by the numeral 210. Battery pack 210 includes a plurality of cylindrical battery cells 212 arranged in aligned rows. Each row may have any number of cells 212, and likewise, any number of rows may be employed. A heat spreader 214 is made of graphite sheet material or extruded graphite and is positioned around each battery cell 212 in a manner which, as will be described below in greater detail, improves thermal performance. In one embodiment, the heat spreader 214 is generally tubular and extends substantially the entire longitudinal length of the battery cell 212. In other embodiments, the heat spreader 214 is longer than the battery cell 212 so that it extends beyond battery cell 212 at one or both ends.

In cross-section each heat spreader 214 includes a square outer wall 216. As can be seen in FIG. 6, a portion of the square outer wall 216 of each heat spreader 214 is arranged to be in generally flush and thermal contact with a portion of the outer wall 216 of at least one adjacent heat spreader 214. A plurality of legs 218 extend inwardly from the outer wall 216. In one embodiment, legs 218 contact the radial outer surface of battery cell 212. In the present embodiment, eight legs 218 are provided, wherein one extends inwardly from each corner formed in the outer wall 216 and one extends inwardly from the mid-point of each leg of the outer wall 216. It should be appreciated, however, that more or fewer legs 218 might be provided. A plurality of interior channels 220 are formed between outer wall 216, the radial outer surface of battery cell 212, and legs 218. In one embodiment, a fluid or gas such as air, may be directed through one or more of the plurality of interior channels 220 to aid in heat removal or regulation.

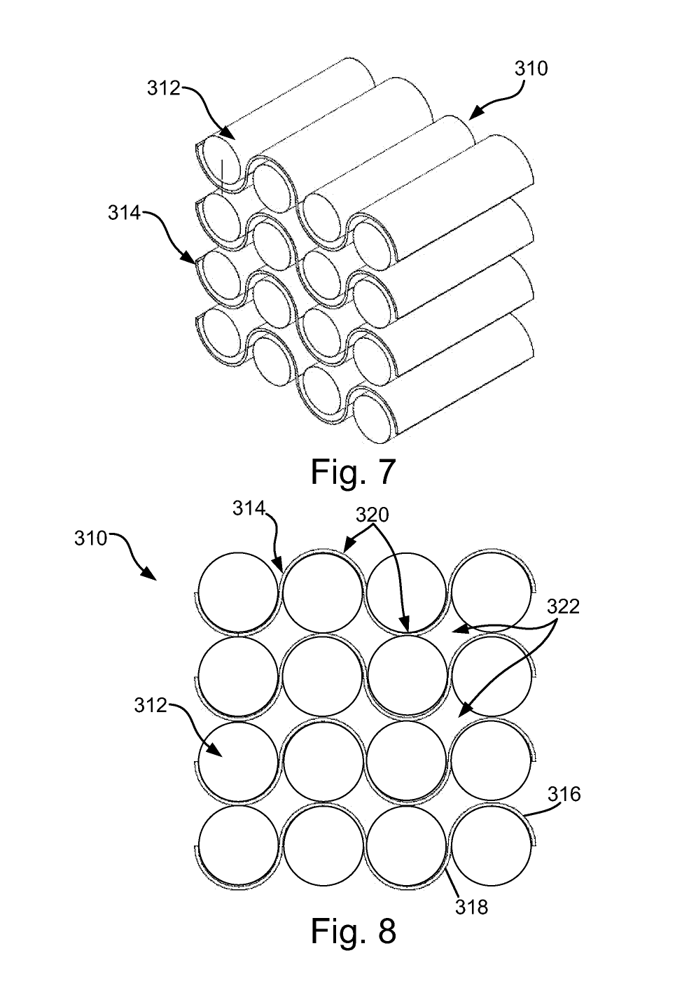

With referenced now to FIGS. 7 and 8, a fourth embodiment of a battery pack is shown and generally indicated by the numeral 310. Battery pack 310 includes a plurality of cylindrical battery cells 312 arranged in aligned rows. Each row may have any number of cells 312, and likewise, any number of rows may be employed. A heat spreader 314 made of a graphite sheet material is provided for each row in a manner which, as will be described below in greater detail, improves thermal performance. In one embodiment, the heat spreader 314 extends substantially the entire longitudinal length of the battery cell 312. In other embodiments, the heat spreader 314 is longer than the battery cell 312 so that a portion extends beyond battery cell 312 at one or both ends.

In cross-section, each heat spreader 314 has a top surface 316 and a bottom surface 318 and is generally wave-shaped having alternating curved portions 320. Curved portions 320 each have a radius sized to match the radius of the radial outer surface of each battery cell 312. Thus, due to the alternating curved arrangement, the top and bottom surface 316, 318 alternately contact each battery cell 312 in a row. In one embodiment, heat spreader 314 contacts up to approximately half the radial outer surface area of each battery cell 312.

An interior channel 322 is formed between the bottom surface 318 of a first heat spreader 314, the top surface 316 of a heat spreader 314 of an adjacent row, and a portion of the radial outer surfaces of two battery cells 312 located in adjacent rows. In one embodiment, a fluid or gas such as air may be directed through one or more of the plurality of interior channels 322 to aid in heat removal or regulation.

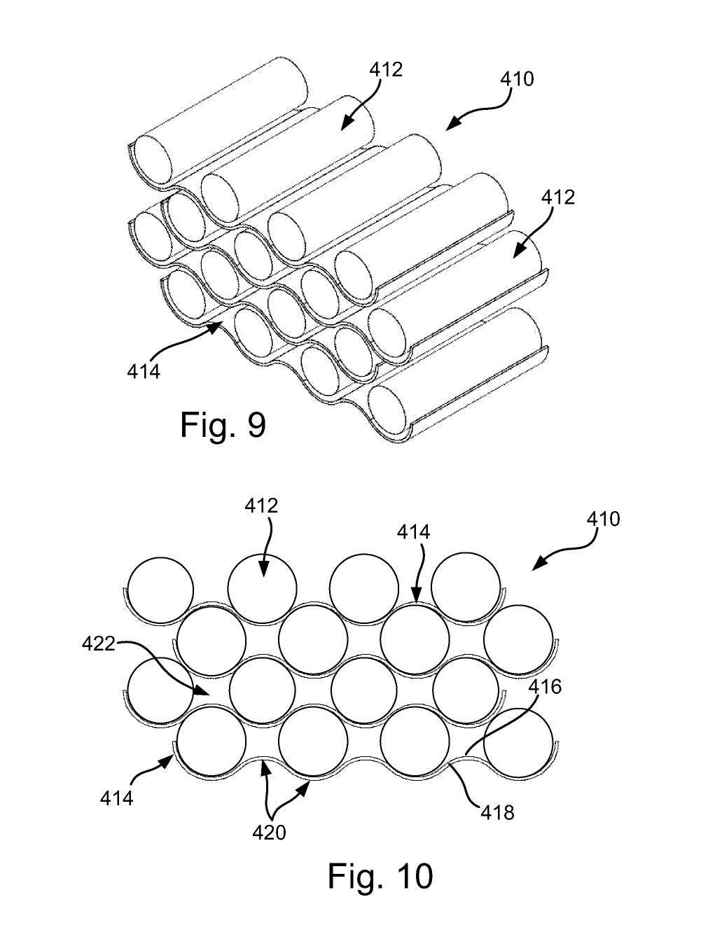

With reference now to FIGS. 9 and 10, a fifth embodiment of a battery pack is shown and generally indicated by the numeral 410. Battery pack 410 includes a plurality of cylindrical battery cells 412 arranged in diagonal rows. In other words, the center-point of a battery cell 412 is aligned with the mid-point between two battery cells in the adjacent row(s). Each row may have any number of cells 412, and likewise, any number of rows may be employed. A heat spreader 414 made of graphite sheet material is provided for each row in a manner which, as will be described below in greater detail, improves thermal performance. In one embodiment, the heat spreader 414 extends substantially the entire longitudinal length of the battery cell 412. In other embodiments, the heat spreader 414 is longer than the battery cell 412 so that it extends beyond battery cell 412 at one or both ends.

In cross-section, each heat spreader 414 has a top surface 416 and a bottom surface 418 and is generally wave-shaped having alternating curved portions 420. Curved portions 420 each have a radius sized to generally match the radius of the outer surface of each battery cell 412. As can be seen in FIG. 10, the top surface 416 of each heat spreader 414 contacts a portion of the radial outer surface of each battery cell 412 in a first row. Likewise, the bottom surface 418 of the same heat spreader 414 contacts a portion of the radial outer surface of each battery cell 412 in the row adjacent too, and below, the first row. According to this arrangement, each battery cell 412 (with the exception of battery cells 412 on the outer periphery the battery pack 410) is contacted by a heat spreader 414 on two opposed sides. Further, each heat spreader 414 (with the exception of those on the periphery) are in thermal contact with the battery cells 412 in two adjacent rows.

An interior channel 422 is formed between the bottom surface 418 of a first heat spreader 414, the top surface 416 of a second adjacent heat spreader 414 of an adjacent row, and a portion of the radial outer surfaces of two adjacent battery cells 412 in a row. In one embodiment, a fluid or gas such as air may be directed through one or more of the plurality of interior channels 422 to aid in heat removal or regulation.

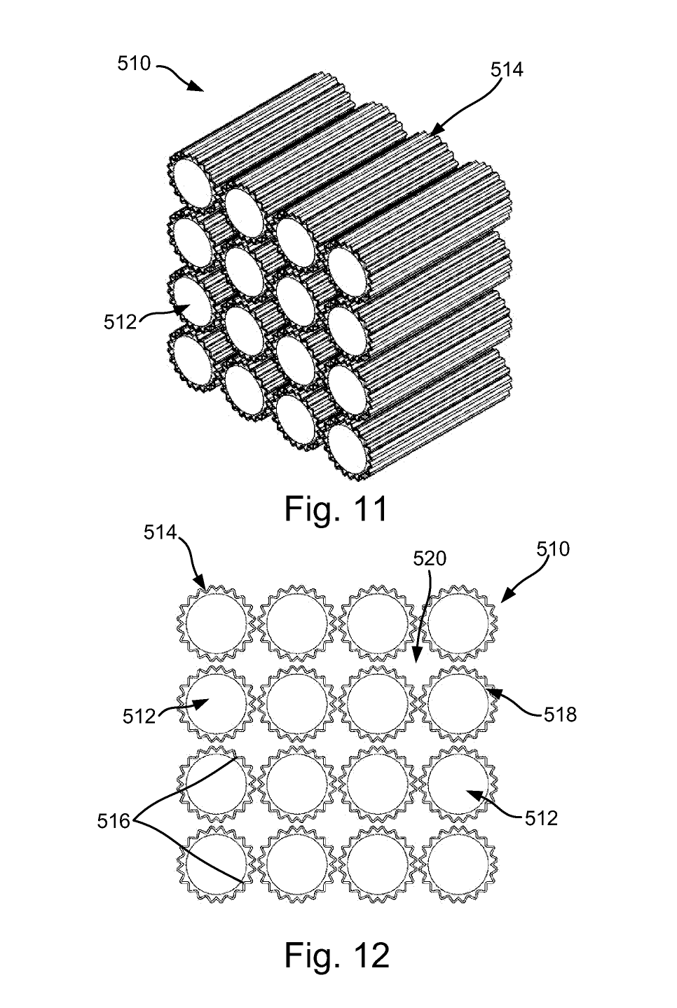

With referenced now to FIGS. 11 and 12, a sixth embodiment of a battery pack is shown and generally indicated by the numeral 510. Battery pack 510 includes a plurality of cylindrical battery cells 512 arranged in aligned rows. Each row may have any number of cells 512, and likewise, any number of rows may be employed. A heat spreader 514 made of a graphite sheet material is provided for each battery cell 512 in a manner which, as will be described below in greater detail, improves thermal performance. In one embodiment, the heat spreader 514 is generally tubular and extends substantially the entire longitudinal length of the battery cell 512. In other embodiments, the heat spreader 514 is longer than the battery cell 512 so that a portion extends beyond battery cell 512 at one or both ends.

In cross-section, each heat spreader 514 extends around the entire circumference of each battery cell 512. The heat spreader 514 includes a repeating pattern that serves to increase the surface area thereof. In the embodiment shown, heat spreader 514 is corrugated, it should be appreciated that other repeating patterns may be used, for example, waves or squares. In one embodiment the heat spreader 514 is sized so that the interior corrugated points 516 contact the radial outer surface of battery cell 512. In other embodiments, the heat spreader 514 is sized so that the interior corrugated points 516 are spaced from the radial outer surface of battery cell 512.

An interior channel 518 is formed between each heat spreader 514 and the battery cell 512 it surrounds. Additional channels 520 are formed at the center-point between four battery cells 512 by a portion of the heat spreader 514 of those for adjoining cells. In one embodiment, a fluid or gas such as air may be directed through one or more of the plurality of channels 518 and/or 520 to aid in heat removal or regulation.

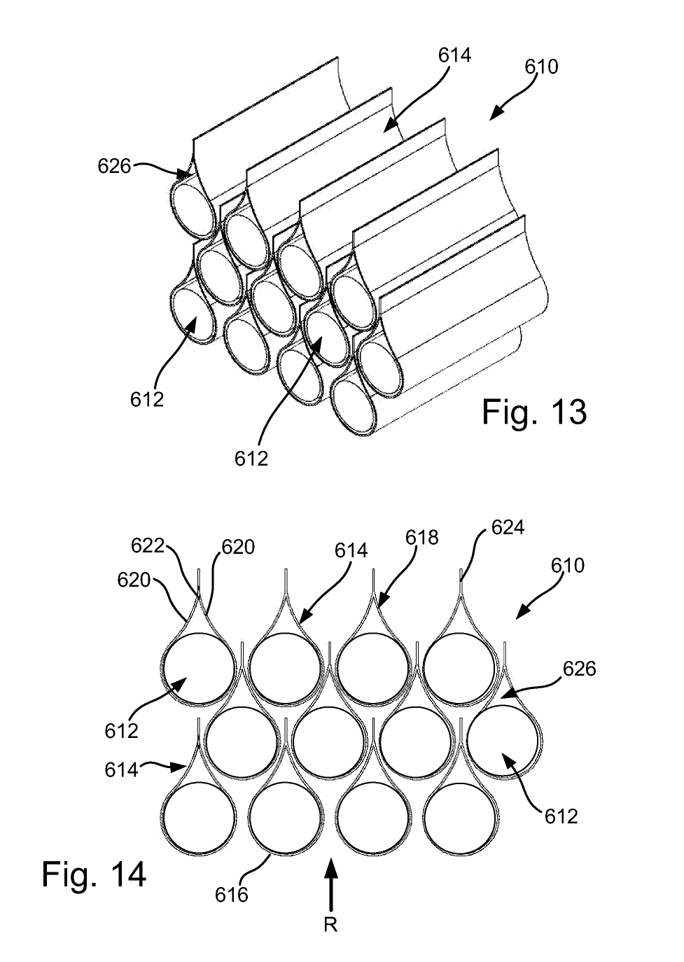

With referenced now to FIGS. 13 and 14, a seventh embodiment of a battery pack is shown and generally indicated by the numeral 610. Battery pack 610 includes a plurality of cylindrical battery cells 612 arranged in diagonal rows. In other words, the center-point of a battery cell 612 is aligned with the mid-point between two battery cells in the adjacent row(s). Each row may have any number of cells 612, and likewise, any number of rows may be employed. A heat spreader 614 made of graphite sheet material is provided for each battery cell 612 in a manner which, as will be described below in greater detail, improves thermal performance. In one embodiment, the heat spreader 614 extends substantially the entire longitudinal length of the battery cell 612. In other embodiments, the heat spreader 614 is longer than the battery cell 612 so that a portion extends beyond battery cell 612 at one or both ends.

In cross-section, each heat spreader 614 is generally teardrop shaped, having a semi-circular portion 616 and a fin 618 that extends away from battery cell 612. Semi-circular portion 616 is sized to be generally flush with and in thermal contact with a portion of the radial outer surface of battery cell 612. Fin 618 includes a pair of legs 620 that extend from each side of semi-circular portion 616. Legs 620 may include a slight radius and are joined at a tip 622, from which extends a single leg 624 that extends in a direction radially away from the associated battery cell 612.

An interior channel 626 is formed between fin 618 and a portion of the radial outer surface of the battery cell 612 it surrounds. In one embodiment, a fluid or gas such as air may be directed through one or more of the plurality of channels 626 to aid in heat removal. Further, given the teardrop/airfoil shape, air may also be directed in the lateral/radial direction R, advantageously aligned with leg 624, to achieve even greater thermal performance.

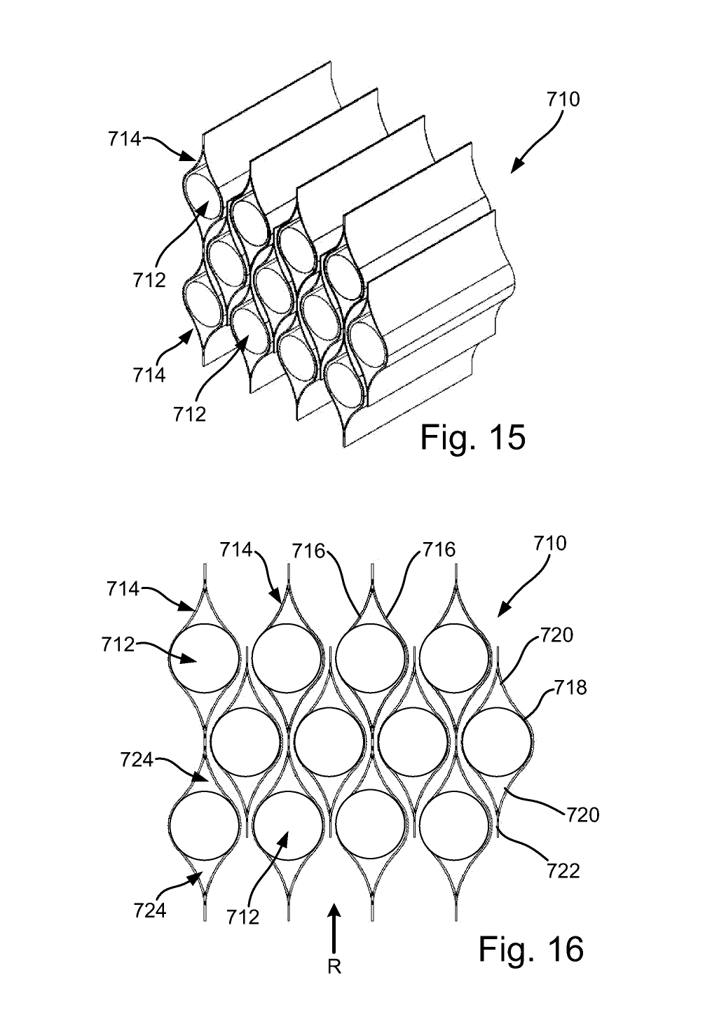

With referenced now to FIGS. 15 and 16, an eighth embodiment of a battery pack is shown and generally indicated by the numeral 710. Battery pack 710 includes a plurality of cylindrical battery cells 712 arranged in diagonal rows. In other words, the center-point of a battery cell 712 is aligned with the mid-point between two battery cells in the adjacent row(s). Each row may have any number of cells 712, and likewise, any number of rows may be employed. A heat spreader 714 made of a graphite sheet material is provided for each battery cell 712 in a manner which, as will be described below in greater detail, improves thermal performance. In one embodiment, the heat spreader 714 extends substantially the entire longitudinal length of the battery cell 712. In other embodiments, the heat spreader 714 is longer than the battery cell 712 so that a portion extends beyond battery cell 712 at one or both ends.

In cross-section, each heat spreader 714 is generally eyelid shaped having two opposed symmetrical halves 716. Each half has a generally concave central portion 718 and convex portions 720 extending each side of the concave central portion 718. A portion of the concave portion 718 of each half 716 contacts a portion of the radial outer surface of the battery cell 712. The convex portions 720 extend outwardly from the battery cell 712 and form a single leg 722 at the meeting point of two convex portions 720. In one embodiment, single leg 722 extends radially away from battery cell 712 associated therewith and extends to at least the center point between two adjacent battery cells.

A pair of opposed interior channels 724 are formed between each heat spreader 714 and the associated battery cell 712. In one embodiment, a fluid or gas such as air may be directed through one or more of the plurality of channels 724 to aid in heat removal. Further, given the aerodynamic shape, air may also be directed in the lateral/radial direction R, advantageously aligned with leg 722, to achieve even greater thermal performance.

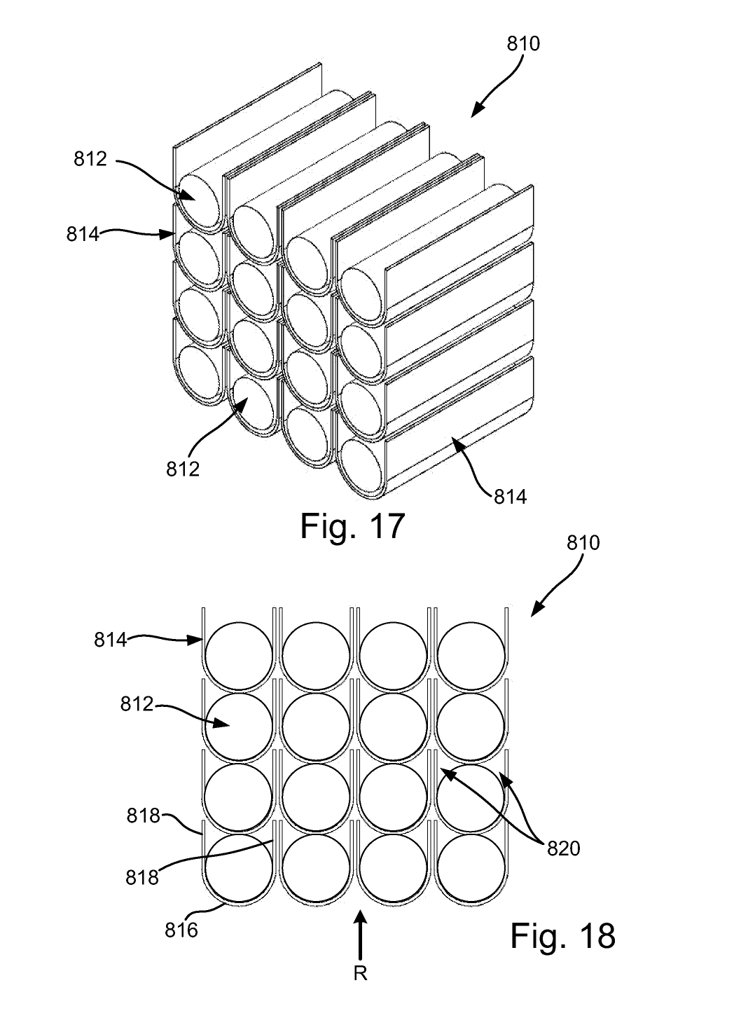

With referenced now to FIGS. 17 and 18, a ninth embodiment of a battery pack is shown and generally indicated by the numeral 810. Battery pack 810 includes a plurality of cylindrical battery cells 812 arranged in aligned rows. Each row may have any number of cells 812, and likewise, any number of rows may be employed. A heat spreader 814 made of a graphite sheet material is provided for each battery cell 812 in a manner which, as will be described below in greater detail, improves thermal performance. In one embodiment, the heat spreader 814 extends substantially the entire longitudinal length of the battery cell 812. In other embodiments, the heat spreader 814 is longer than the battery cell 812 so that a portion extends beyond battery cell 812 at one or both ends.

In cross-section, each heat spreader 814 is generally U-shaped having a semi-circular portion 816 and a pair of legs 818 extending from semi-circular portion 816. In one embodiment, legs 818 extend in a direction tangent to the radial outer surface of battery cell 812. In this or other embodiments, the legs 818 of a heat spreader are parallel to each other. In one embodiment, the battery cells 812 are spaced so that the leg 818 of one heat spreader 814 is parallel to, and spaced from, the leg 818 of the heat spreader 814 associated with the adjacent battery cell 812 in the row. In another embodiment, the battery cells 812 are spaced so that the leg 818 of one heat spreader 814 is parallel to and in thermal contact with, the leg 818 of the heat spreader 814 associated with the adjacent battery cell 812 in the row. In one embodiment, the battery cells 812 are spaced so that the semi-circular portion of each heat spreader 814 contacts two battery cells 812.

A pair of channels 820 are formed between legs 818 and the radial outer surface of the battery cell 812. In one embodiment, a fluid or gas such as air may be directed through one or more of the plurality of channels 820 to aid in heat removal or regulation. Further, given the aerodynamic shape, air may also be directed in the lateral/radial direction R, advantageously aligned with leg 818, to achieve even greater thermal performance.

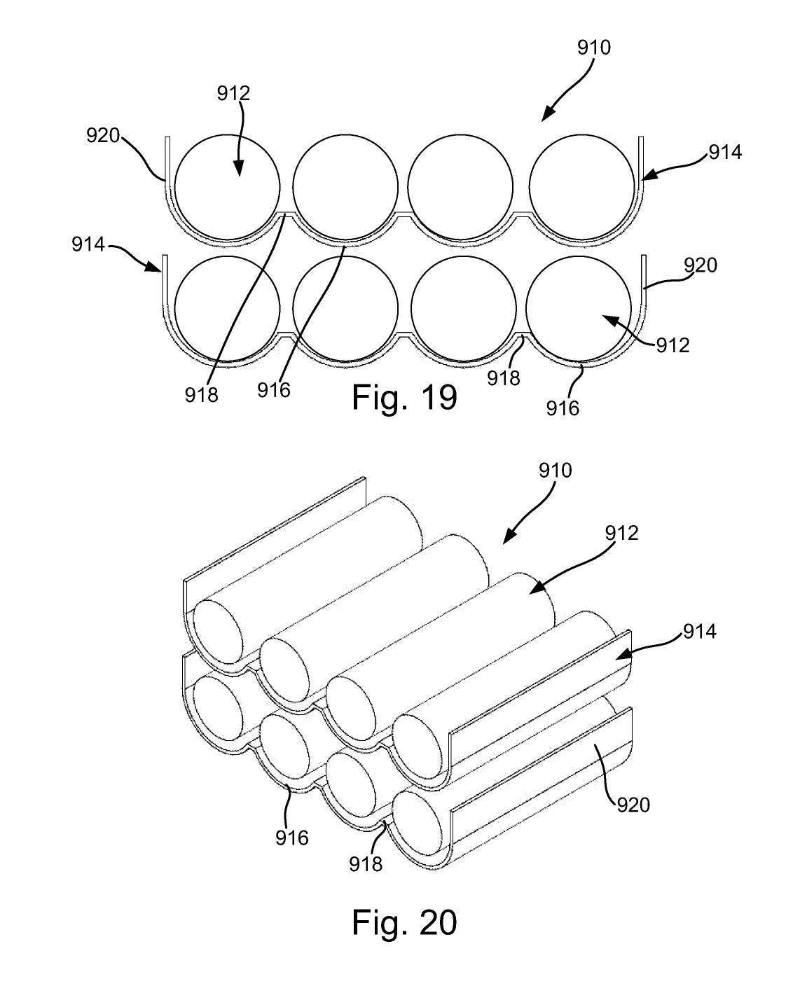

With referenced now to FIGS. 19 and 20, a tenth embodiment of a battery pack is shown and generally indicated by the numeral 910. Battery pack 910 includes a plurality of cylindrical battery cells 912 arranged in aligned rows. Each row may have any number of cells 912, and likewise, any number of rows may be employed. A heat spreader 914 made of a graphite sheet material is provided for each row of battery cells 912 in a manner which, as will be described below in greater detail, improves thermal performance. In one embodiment, the heat spreader 914 extends substantially the entire longitudinal length of the battery cell 912. In other embodiments, the heat spreader 914 is longer than the battery cell 912 so that a portion extends beyond battery cell 912 at one or both ends.

In cross-section, each heat spreader 914 spans the length of a row of battery cells 912 and includes a plurality of spaced semi-circular portions 916. Each semi-circular portion is sized to receive and be in thermal contact with a portion of the radial outer surface of a battery cell 912. A generally flat linking portion 918 extends between each semi-circular portion 916. At the end of each row of battery cells 912, a leg 920 extends upwardly from the outer end of the semi-circular portion 916 in a direction substantially perpendicular to linking portions 918. In one embodiment, leg 920 extends upwardly to the height of the battery cell 912.

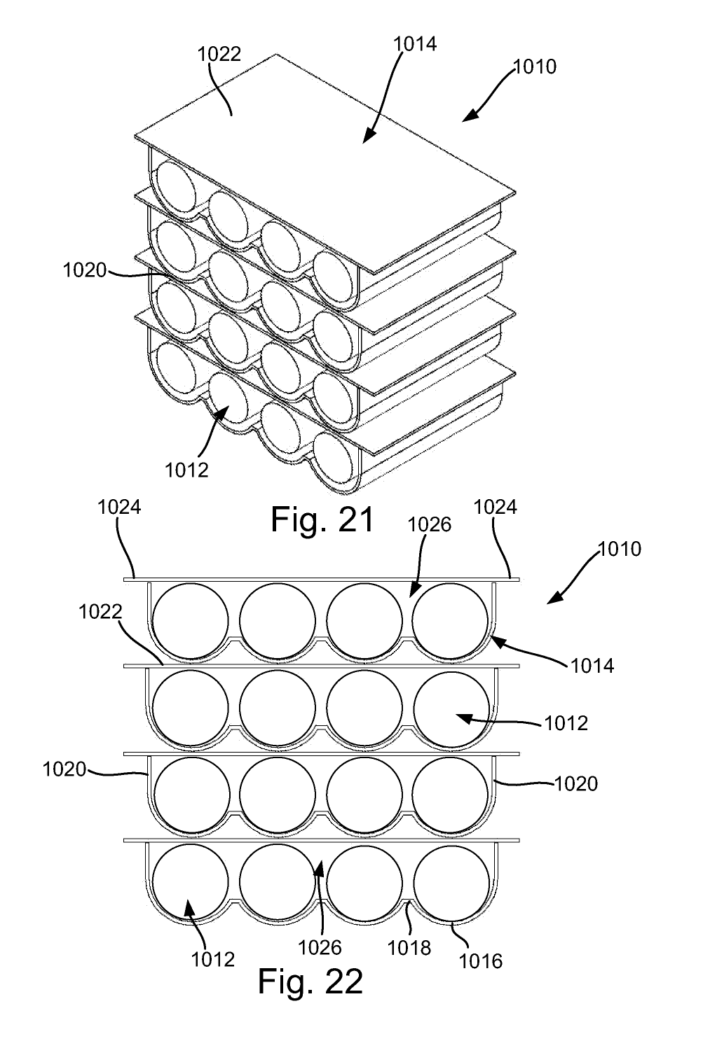

With referenced now to FIGS. 21 and 22, an eleventh embodiment of a battery pack is shown and generally indicated by the numeral 1010. Battery pack 1010 includes a plurality of cylindrical battery cells 1012 arranged in aligned rows. Each row may have any number of cells 1012, and likewise, any number of rows may be employed. A heat spreader 1014 made of graphite sheet material is provided for each row of battery cells 1012 in a manner which, as will be described below in greater detail, improves thermal performance. In one embodiment, the heat spreader 1014 extends substantially the entire longitudinal length of the battery cell 1012. In other embodiments, the heat spreader 1014 is longer than the battery cell 1012 so that a portion extends beyond battery cell 1012 at one or both ends.

In cross-section, each heat spreader 1014 spans the length of a row of battery cells 1012 and includes a plurality of spaced semi-circular portions 1016. Each semi-circular portion is sized to receive and be in thermal contact with a portion of the radial outer surface of a battery cell 1012. A generally flat linking portion 1018 extends between each semi-circular portion 1016. At the end of each row of battery cells 1012, a leg 1020 extends upwardly from the outer end of the semi-circular portion 1016 in a direction substantially perpendicular to linking portions 1018. In one embodiment, leg 1020 extends upwardly to the entire diameter of the battery cell 1012. A generally planar top sheet 1022 extends between each leg 1020. In one embodiment top sheet 1022 extends beyond each leg 1020 to form overlapping portions 1024. In this manner top sheet 1022 forms an interior channel 1026 within which the battery cells 1012 of a row are carried. In one embodiment, a fluid or gas such as air may be directed through one or more of the interior channel 1026 to aid in heat removal.

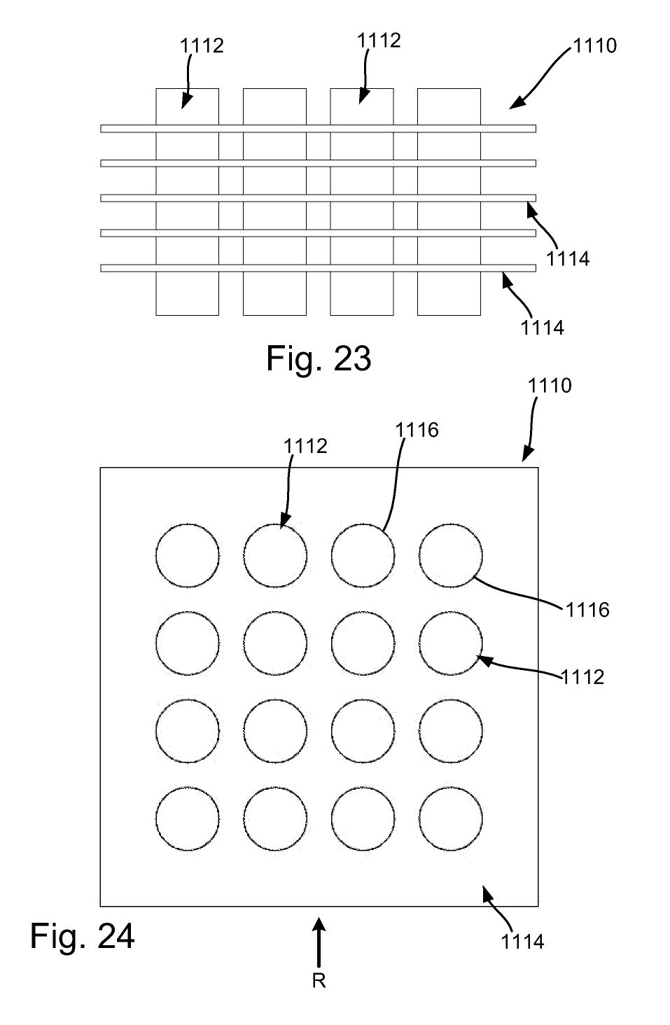

With referenced now to FIGS. 23 and 24, a twelfth embodiment of a battery pack is shown and generally indicated by the numeral 1110. Battery pack 1110 includes a plurality of cylindrical battery cells 1112 arranged in aligned rows. Each row may have any number of cells 1112, and likewise, any number of rows may be employed. A plurality of heat spreaders 1114 made of graphite sheet material or thermally conductive graphite foams is provided and are spaced along the longitudinal direction of battery cells 1112 in a manner which, as will be described below in greater detail, improves thermal performance.

the heat spreader 1114 shown in FIG. 24 is generally square it should be appreciated that other shapes may be employed such as, for example, rectangular, circular or irregular shaped. Each heat spreader 1114 includes a plurality of holes 1116 sized to receive a battery cell 1112 therein. In one embodiment, the holes 1116 are sized so that battery cell 1112 is received therein in a press-fit. The side walls of each hole 1116 is generally flush and in thermal contact with the radial outer surface of the battery cell 1112 received therein. In this manner, each heat spreader draws thermal energy from the cells to help create thermal homogeneity and remove heat from the battery pack. In one embodiment, a fluid or gas such as air may be directed in the lateral/radial direction R to aid in heat removal or regulation.

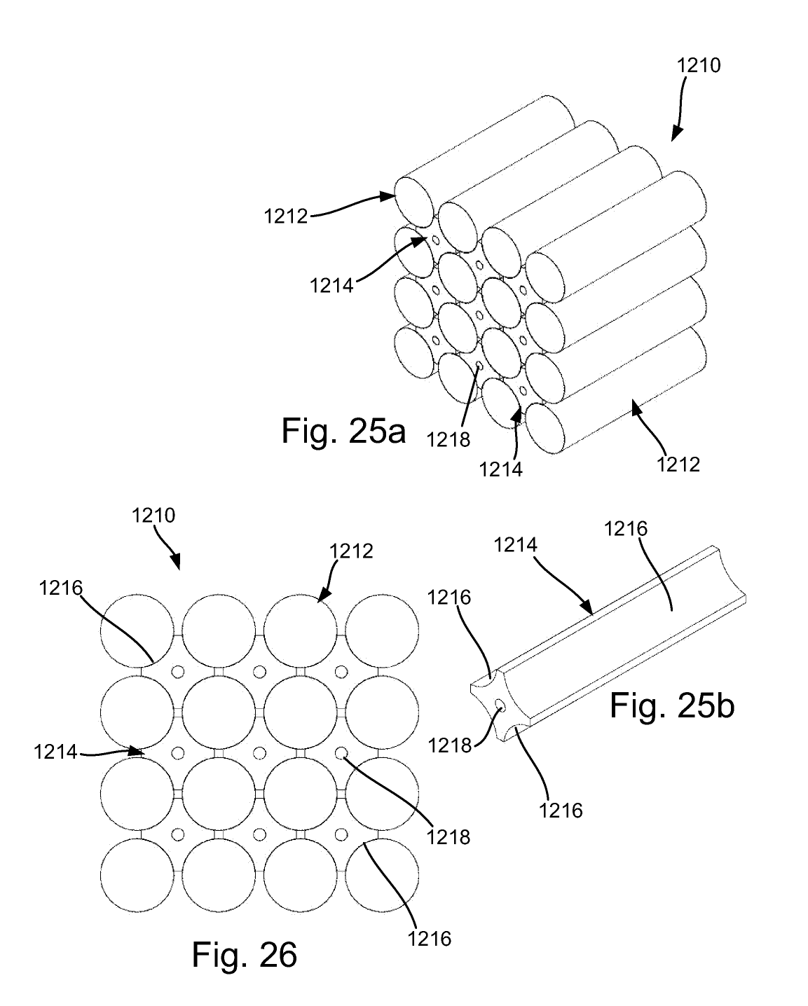

With reference now to FIGS. 25 and 26, a thirteenth embodiment of a battery pack is shown and generally indicated by the numeral 1210. Battery pack 1210 includes a plurality of cylindrical battery cells 1212 arranged in aligned rows. Each row may have any number of cells 1212, and likewise, any number of rows may be employed. A heat spreader 1214 made of graphite sheet material, thermally conductive graphite foams or extruded graphite is provided in the area between battery cells 1212 in a manner which, as will be described below in greater detail, improves thermal performance. In one embodiment, the heat spreader 1214 extends substantially the entire length of the battery cell 1212. In other embodiments, the heat spreader 1214 is longer than the battery cell 1212 so that a portion extends beyond battery cell 1212 at one or both ends.

In cross-section, each heat spreader 1214 is shaped generally as a four-pointed star. The star shape is formed by four circumferentially spaced concave surfaces 1216. In one embodiment, surfaces 1216 include a radius substantially the same as the radius of the radial outer surface of the battery cell 1212. Thus, when positioned at the center-point between four battery cells 1212, each concave surface 1216 of the heat spreader 1214 contacts the radial outer surface of a different battery cell 1212. Each heat spreader 1214 may include a central bore 1218 that extends the entire longitudinal length of heat spreader 1214. In one embodiment, a fluid or gas such as air may be directed through one or more of the bores 1218 to aid in heat removal or regulation.

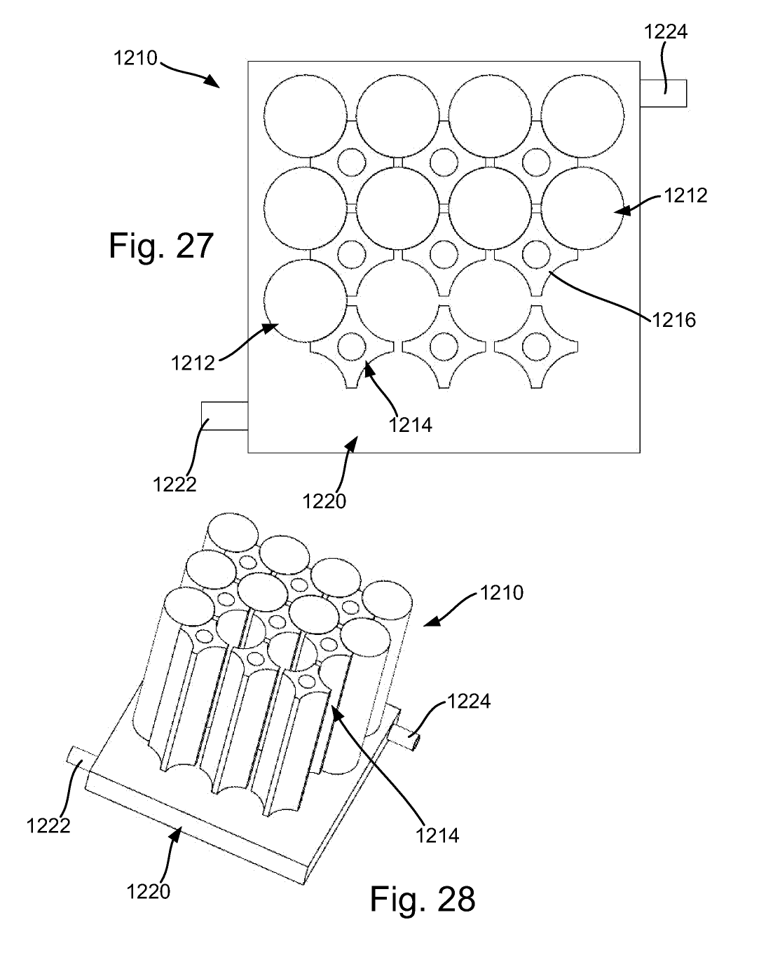

With reference now to FIGS. 27 and 28, heat spreader 1214 may be used in conjunction with a heat exchanger 1220 positioned at one or both ends of the battery cells 1212 and in contact with one or both ends of heat spreaders 1214. Heat exchanger 1220 may include a fluid input 1222 and output 1224 to allow the movement of a heat carrying medium into and out of the heat exchanger 1220. In this manner, heat may be carried along heat spreaders 1214 and transferred to the medium in the heat exchanger 1220.

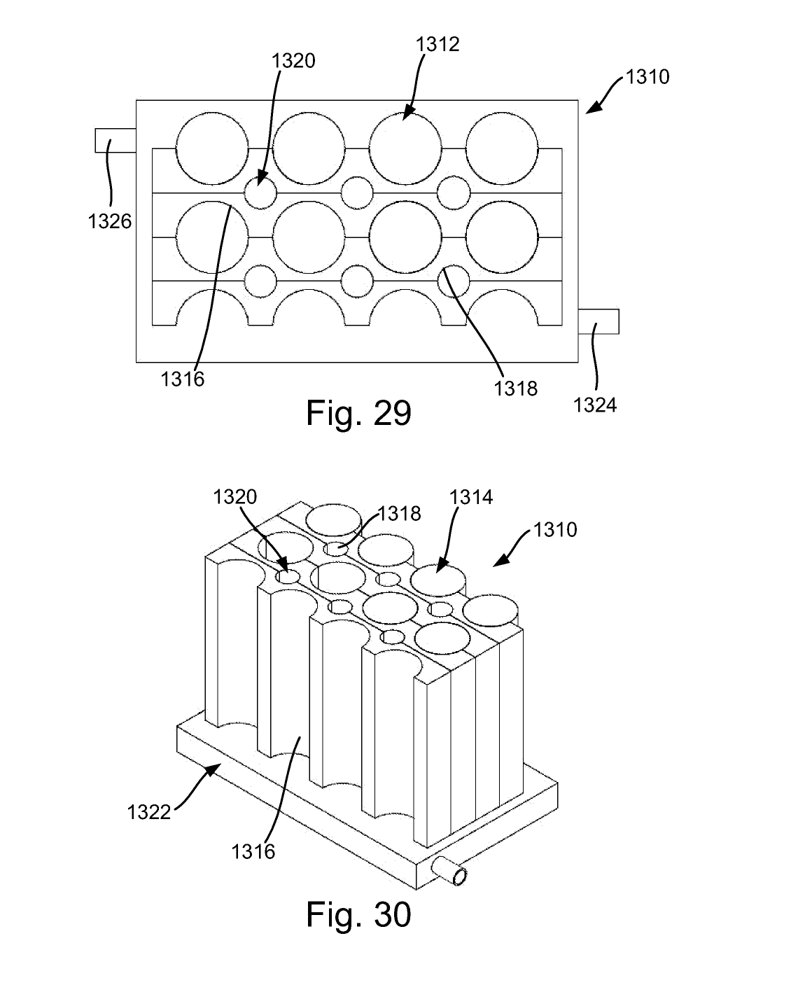

With reference now to FIGS. 29 and 30, a fourteenth embodiment of a battery pack is shown and generally indicated by the numeral 1310. Battery pack 1310 includes a plurality of cylindrical battery cells 1312 arranged in aligned rows. Each row may have any number of cells 1312, and likewise, any number of rows may be employed. One or two heat spreaders 1314 made of graphite sheet material, thermally conductive graphite foams or extruded graphite are provided in for each row in a manner which, as will be described below in greater detail, improves thermal performance. In one embodiment, the heat spreader 1314 extends substantially the entire length of the battery cell 1312. In other embodiments, the heat spreader 1314 is longer than the battery cell 1312 so that a portion extends beyond battery cell 1312 at one or both ends.

In cross-section each heat spreader 1314 is generally rectangular having a plurality of spaced semi-circular cut-outs 1316, each sized to at least partially receive a battery cell 1312 therein. In one embodiment, a pair of heat spreaders 1314 are positioned on opposed sides of a row and configured so that the opposed cut-outs 1316 form a circular bore that receives a battery cell 1312 therein. In this embodiment, the bore may be sized so that the battery cell 1312 is held substantially flush therein. Each heat spreader 1314 further includes a slot 1318 on the side of heat-spreader 1314 opposed from the semi-circular cut-out 1316. Slots 1318 from adjacent heat spreaders 1314 align to form channels 1320 that extend the length of the heat spreader 1314. In one embodiment, a fluid or gas such as air may be directed through one or more of the interior channel 1320 to aid in heat removal or regulation.

Heat spreader 1314 may be used in conjunction with a heat exchanger 1322 positioned at one or both ends of the battery cells 1312 and in contact with one or both ends of heat spreaders 1314. Heat exchanger 1322 may include a fluid input 1324 and output 1326 to allow the movement of a heat carrying medium into and out of the heat exchanger. In this manner, heat may be carried along heat spreaders 1314 and transferred to medium in the heat exchanger 1322.

In any of the above embodiments, at least one of the spaces between the heat spreaders is at least partially filled with a layer of a phase change material. In another embodiment at least one of the spaces between the heat spreaders is completely filled with a layer of a phase change material. In these or other embodiments, substantially all of the spaces between the heat spreaders includes a phase change material. For example, in the embodiment of FIG. 23, phase change material may be positioned between each heat spreader 1114, thus forming an alternating stack of heat spreaders 1114 and phase change material. The phase change material may be free flowing and contained or bound at least partially by the heat spreaders. Alternately, the phase change material may be physically adsorbed into a carrying matrix. For example, the phase change material may be absorbed and carried in a compressed expanded graphite mat or carbon foam. The phase change material would help reduce the magnitude and speed of temperature changes in the battery pack. The melting temperature range of the phase change material may advantageously be approximately equal to the recommended operating temperature range for the battery cells within the battery pack. An example of a suitable phase change material is a paraffin wax.

In any one or more of the above embodiments, the heat spreader may further be a composite material. For example, each heat spreader may include a pair of graphite sheets having a phase change material disposed therebetween. The phase change material may be free flowing and contained or bound by the graphite sheets. Alternately, the phase change material may be physically adsorbed into a carrying matrix that is positioned between the opposed graphite sheets. For example, the phase change material may be absorbed and carried in a compressed expanded graphite mat or carbon foam. In the alternative, the composite material may include a single graphite sheet layer secured to a single carrying matrix layer having the phase change material absorbed therein.

It should be appreciated that, in each of the above embodiments, only a single cell is shown extending in the longitudinal direction, more than one battery cell may be configured in a stacked arrangement in the longitudinal direction, in addition to the stacking in rows and columns as shown.

In each of the above embodiments, a heat exchanger may be provided at one or both ends of the battery pack. In one or more embodiments the heat spreader surrounding each battery cell extends beyond the battery cell and contacts a heat exchanger.

The above description is intended to enable the person skilled in the art to practice the invention. It is not intended to detail all of the possible variations and modifications that will become apparent to the skilled worker upon reading the description. It is intended, however, that all such modifications and variations be included within the scope of the invention that is defined by the following claims. The claims are intended to cover the indicated elements and steps in any arrangement or sequence that is effective to meet the objectives intended for the invention, unless the context specifically indicates the contrary.

What is claimed:

1. A battery pack comprising:
a plurality of cylindrical battery cells having a longitudinal length and a radial outer surface, said cylindrical battery cells being arranged in at least one linear row; and
at least one heat spreader comprised of a graphite sheet and extending at least substantially the entire longitudinal length of said cylindrical battery cells and the entire length of said linear row; and
wherein a single heat spreader contacts at least a portion of said radial outer surface of each said cylindrical battery in said row.

2. The battery pack of claim 1 wherein said graphite sheet comprises compressed expanded natural graphite.

3. The battery pack of claim 1 wherein said graphite sheet comprises resin impregnated compressed natural graphite sheet.

4. The battery pack of claim 1 wherein said graphite sheet comprises graphitized polyimide sheet.

5. The battery pack of claim 1 wherein said heat spreader includes a top surface and a bottom surface, said heat spreader contacting said battery cells in said row alternately on said top surface and said bottom surface.

6. The battery pack of claim 1 wherein said heat spreader includes a plurality of semi-circular portions in cross-section, each said semi-circular portion receiving a portion of the radial outer surface of each battery cell in said row.

7. The battery pack of claim 1 wherein a leg extends perpendicular to said row at opposed ends of said heat spreader.

8. The battery pack of claim 7 wherein said heat spreader further comprises a top sheet that extends between said legs and forms an interior channel.

9. A battery pack comprising:
a plurality of cylindrical battery cells having a longitudinal length and a radial outer surface; and
a plurality of heat spreaders comprised of a graphite sheet, each said cylindrical battery being positioned in a heat spreader, said heat spreader extending at least substantially the entire longitudinal length of said battery cell and contacting at least a portion of said radial outer surface.

10. The battery pack of claim 9 wherein said heat spreaders are piscine shaped in cross-section.

11. The battery pack of claim 9 wherein said heat spreaders are cruciform shaped in cross-section.

12. The battery pack of claim 9 wherein said heat spreaders each include a square outer wall and a plurality of legs extending inwardly, at least one of said legs contacting said radial outer surface of said battery cell.

13. The battery pack of claim 9 wherein said heat spreaders having a corrugated cross-section.

14. The battery pack of claim 9 wherein said heat spreaders are eyelid shaped in cross-section.

15. The battery pack of claim 9 wherein said heat spreaders are teardrop shaped in cross-section.

16. The battery pack of claim 9 wherein said heat spreaders are U-shaped in cross-section.

17. The battery pack of claim 9 wherein a longitudinally extending channel is formed between each said heat spreader and an associated battery cell.

18. The battery pack of claim 9 wherein said graphite sheet comprises compressed expanded natural graphite.

19. The battery pack of claim 9 wherein said graphite sheet comprises resin impregnated compressed natural graphite sheet.

20. The battery pack of claim 9 wherein said graphite sheet comprises graphitized polyimide sheet.
